(19) United States
(12) Patent Application Publication
(10) Pub. No.: US 2026/0102863 A1
(43) Pub. Date: Apr. 16, 2026

(54) A DUST EXTRACTOR WITH ONE OR MORE LOAD SENSORS

(71) Applicant: HUSQVARNA AB, Huskvarna (SE)

(72) Inventors: Axel SJOBERG, Vastra Frolunda (SE); Daniel GUSTAVSSON, Soderkoping (SE); David KACKER, Soderkoping (SE); Viktor LAURSEN, Linghem (SE); Linus OTTOSSON, Norsholm (SE)

(21) Appl. No.: 19/120,777

(22) PCT Filed: Oct. 20, 2023
(86) PCT No.: PCT/EP2023/079221

§ 371 Date: Apr. 13, 2025

(30) Foreign Application Priority Data
Oct. 20, 2022 (SE) 2251225-5
Jun. 19, 2023 (SE) 2350747-8
Jun. 19, 2023 (SE) 2350748-6
Jun. 19, 2023 (WO) PCT/SE2023/050629

(51) Int. Cl. B23Q 11/00; A47L 7/00; A47L 9/10; A47L 9/12; A47L 9/14; A47L 9/20; A47L 9/28; B01D 46/46; B01D 46/58; B01D 46/71; G01C 21/16; G01G 19/52

(52) U.S. Cl. CPC B23Q 11/0046; A47L 7/0095; A47L 9/102; A47L 9/12; A47L 9/149; A47L 9/20; A47L 9/2805; A47L 9/2836; A47L 9/2894; B01D 46/46; B01D 46/58; B01D 46/71; G01C 21/16; G01G 19/52; B01D 2279/55

(57) ABSTRACT

A heavy-duty dust extractor (100, 200, 300, 400, 500, 600) comprising a dust separator (110), wherein the heavy-duty dust extractor is arranged to be supported on a ground surface (101) by one or more support members (150, 160), where one or more load sensors (210, 220) are arranged in connection to the one or more support members (150, 160) to measure a load on the one or more support members (150, 160), the dust extractor comprising a control unit (170, 900) arranged to receive data indicative of the load measured by the one or more load sensors (210, 220), where the control unit (170, 900) comprises means for measuring time, where the control unit (170, 900) is arranged to determine a dust extraction rate (740) in terms of a weight of extracted dust per unit of time based on the received data, and to control an operation of the heavy-duty dust extractor based on the determined dust extraction rate.

### TECHNICAL FIELD

The present disclosure relates to heavy-duty dust extractors suitable for extracting dust and slurry generated when processing concrete surfaces and other concrete objects. The disclosure also relates to construction equipment such as floor grinders, power cutters, concrete wall saws, shavers, scarifiers, shot blasters, steel blasters and core drills arranged to operate together with a heavy-duty dust extractor. Some aspects of the disclosure also relate to remote control devices and display units.

### BACKGROUND

Concrete is a commonly occurring building material. Concrete surfaces are for instance used for flooring in both domestic and industrial facilities. Concrete is also used in walls, ceilings, and other supporting structures as well as in various ornaments.

Floor grinders, shavers, scarifiers, shot blasters and steel blasters can be used to efficiently process a concrete surface in order to, e.g., obtain a level surface having a uniform topology and/or a surface having a desired surface texture.

Power cutters, wall saws, and core drills can be used to shape concrete objects.

There is a need for improved concrete processing construction equipment which is both efficient and convenient for an operator to use.

A significant amount of dust and slurry may be generated when processing concrete surfaces and other objects. Dust can be harmful to a machine operator and slurry generally makes a construction site untidy. The dust and slurry is therefore collected using a dust extractor. There is a need for more efficient dust extractors.

CN105662279 B relates to an industrial vacuum cleaner comprising a frame body, a suction fan, a dust collection bucket, and a controller.

### SUMMARY

It is an objective of the present disclosure to provide improved dust extractors and related construction equipment. This objective is at least in part obtained by a heavy-duty dust extractor comprising a dust separator arrangement such as a cyclone and/or a coarse pre-filter arranged upstream from a finer essential filter such as a HEPA filter or the like. The heavy-duty dust extractor is arranged to be supported on a ground surface by one or more support members, where at least one load sensor is arranged in connection to a support member to measure a load on the support member. The dust extractor also comprises a control unit arranged to receive data from the load sensor or sensors indicative of the load measured by the one or more load sensors. The control unit also comprises means for measuring time and is arranged to determine a dust extraction rate associated with a weight of extracted dust per unit of time based on the received data. The control unit is furthermore arranged to control an operation of the heavy-duty dust extractor and/or of associated construction equipment based on the determined dust extraction rate. This way a number of dust weight dependent operations of the dust extractor can be controlled in a reliable and cost-effective manner, as will be explained in the following. The means for measuring time may vary in complexity from a simple timer or the like to more advanced arrangements for measuring passage of time, such as a clock arranged to be calibrated regularly by an external time reference. The term dust extraction rate is to be construed broadly herein as will be discussed in more detail below. A dust extraction rate can, for instance, be determined as an absolute rate in units of, e.g., kg/min, or as a relative rate compared to a reference dust extraction rate. A dust extraction rate can also be given as a unitless value on a scale, e.g., a scale from one to ten, where, e.g., one is a low dust extraction rate and ten is a high dust extraction rate.

Many of the advantages obtained from the teachings herein are related specifically to the load sensor or sensors arranged in connection to the support member or members of the dust extractor. However, some technical features disclosed herein are not dependent on a specific type of load sensor but are more generally applicable.

Several different operations controlled by the control unit based on the determined dust extraction rate are possible. For instance, the control unit may control a display device on the dust extractor or a display device remote from the dust extractor to indicate the current dust extraction rate, such that a user receives information about the dust extraction rate in real time in a convenient manner. Various notification and alarm functions can also be implemented, such as functions involving notifying a user in case the dust extraction rate exceeds an upper threshold and/or falls short of a lower threshold. The control unit may also be arranged to configure a fan power setting of the dust extractor based on the determined dust extraction rate. This way fan power can be increased in case dust extraction rate is high, and decreased otherwise, e.g., to save power. The reference dust extraction rates for controlling fan power are preferably set in dependence of the current fan power.

Some of the technical features and operations discussed herein relate to dust extraction rate, while other features relate to accumulated dust weight at one or more places in the dust extractor. The features are used with advantage in combination, but many features can also be used separately from each other, in particular some operations described herein that are based on dust extraction rate and some operations described herein that are based on accumulated dust weight.

According to some aspects, the control unit is arranged to determine a time variation in dust extraction rate, e.g., in terms of a weight of extracted dust per time unit squared or a decrease in dust extraction rate over time, and to compare the determined time variation in dust extraction rate to one or more predetermined thresholds. The control unit can then trigger an operation of the dust extractor in case the time variation in dust extraction rate exceeds an upper threshold and/or breaches a lower threshold. A change in dust extraction rate over time perhaps to a stationary dust extraction rate from a time varying dust extraction rate may indicate that it is time to change concrete processing tool, or that a work task is completed.

The one or more support members may, for instance, comprise a wheel, in which case the load sensor can be arranged in connection to the wheel. This placement is advantageous in that it is easily accessible and suitable for measuring the total weight of the dust extractor. A wheel with a load sensor can for instance be a swiveling front wheel of the dust extractor. Such swiveling front wheels are normally arranged to rotate about a central vertical axle. The load sensor can be arranged around this axle to measure a load on the swiveling wheel.

The load sensor preferably comprises a load cell arranged to generate an electrical signal based on a tension, compression, pressure, or torque exerted by the ground surface on the support member. Such load sensors are robust devices which provide accurate load data, which is an advantage. The use of load cells is particularly advantageous in environments where dirt tends to accumulate, such as at construction sites.

The load sensor may also comprise a pressure sensor arranged inside a tyre on a wheel that supports the dust extractor. Such tyre pressure sensors are known as tyre pressure monitoring system (TPMS) sensors in the automotive industry, where they are used to monitor tyre pressure. A TPMS sensor is normally connected to the control unit of the dust extractor via wireless link. TPMS sensors represent a cost-efficient way to measure load on a dust extractor support member that comprises some form of tyre.

According to some aspects, the heavy-duty dust extractor comprises an inertial measurement unit (IMU). The control unit can then be arranged to process the data indicative of the load measured by the load sensor, conditioned on that the IMU outputs a signal indicative of dust extractor spatial stationarity. By processing the load signal or signals also based on the output of the IMU, a more reliable weight determination can be performed. This is because the load data from the load sensors is likely to be disturbed when the dust extractor is subject to external forces such as when it is moved or being subject to vibration of some sort. The data indicative of the load measured by the load sensor may also be disturbed when a user handles the dust extractor in some way, such as when emptying the dust container. A user pulling out a new section of a Longopac dust container system is, for instance, likely to generate a disturbance in the load measured by the load sensor. Regardless of whether an IMU signal is available to the control unit or not, the control unit can be arranged to determine the dust extraction rate and/or a weight of extracted dust by averaging the data indicative of the load measured by the load sensor, in order to suppress transients which could otherwise have a negative effect on the accuracy of the determined dust extraction rate of the dust extractor. However, if an IMU is available, then the control unit can be arranged to process the data at least partly based on the signal from the IMU indicative of dust extractor stationarity, in order to further improve the robustness of the weight determination. Less averaging can for instance be applied to the measurement data when the dust extractor is stationary compared to when the IMU output signal indicates motion by the dust extractor.

According to other aspects, the heavy-duty dust extractor comprises an electronic spirit level arranged to determine an angle of the ground surface relative to a horizontal plane. The control unit can then be arranged to compensate the data indicative of the load measured by the one or more load sensors based on the angle. It is appreciated that, if the dust extractor is not supported on a ground surface aligned with the horizontal plane, then the weight on the support members may be distributed unevenly, i.e., more weight may be transferred to the rear wheels or to the front wheels depending on in which direction the dust extractor is tilted. This uneven distribution of weight can be compensated for by the control unit based on the data from the electronic spirit level. The electronic spirit level may be arranged to provide a vector-valued angle, i.e., in two or three dimensions with respect to the horizontal plane, in order to measure tilt in more than one direction. In this regard it may also be advantageous to configure the support members with soft surfaces able to absorb at least some unevenness in the ground surface, such as smaller stones and the like.

The heavy-duty dust extractor may furthermore comprise a separating structure load sensor, such as a hatch load sensor arranged to measure a load exerted on a hatch mechanism of the dust extractor, or a grate load sensor arranged to measure a load exerted on a grate of the dust extractor between a dust separator and a dust container. The control unit can then be arranged to receive data indicative of the load measured by the separating structure load sensor, and to determine a weight of dust supported by the separating structure, i.e., a load of dust and slurry inside the dust separator, based on the data indicative of the load measured by the separating structure load sensor. This is an advantage since the control unit can then determine if an unacceptable amount of dust and slurry has accumulated on top of the separating structure, which could be indicative of malfunction in, e.g., a hatch mechanism that if fully functional should regularly dump dust and slurry from the dust separator into a dust container arranged below the dust separator.

According to some aspects, the control unit is arranged to determine or at least approximate the amount of dust and slurry held inside the dust separator by integrating the dust extraction rate over a time period that has elapsed since the last emptying operation, where dust and slurry was evacuated from inside the dust separator and into a dust container.

The dust extractors and the construction equipment discussed herein normally generate either dust or slurry. A dust extractor according to the teachings herein may extract either dust or slurry depending on which type of construction equipment it is currently associated with. Some operations are wet operations that generate slurry that is extracted by the dust extractor, while other operations are dry operations that generate dust to be extracted. It is appreciated that some dust can be generated during a wet operation, and vice versa. The weight of the material extracted by a dust extractor will be referred to as the weight of the dust and slurry herein, although it is understood that normally the weight referred to is the weight of dust or the weight of slurry, depending on the operation that is being performed.

According to some aspects, the heavy-duty dust extractor comprises a dust container load sensor arranged to measure a load exerted on a dust container of the dust extractor, the control unit can then be arranged to receive data indicative of the load measured by the dust container load sensor, and to determine a weight of dust supported by the dust container, based on the data indicative of the load measured by the dust container load sensor. The weight of dust supported by the dust container and the weight of dust held inside the dust separator is often the total weight of dust supported by the dust extractor.

It is an advantage to have information regarding the weight of dust supported by the dust container since the operator can then be notified when it is time to empty the dust container, in order to avoid excessively heavy dust containers that could be difficult to handle manually.

According to other aspects, the control unit is arranged to trigger activation of a notification function of the dust extractor in case the weight of dust supported by the separating structure mechanism, the weight of dust held inside the dust separator, or the weight of dust supported by the dust container exceeds respective weight thresholds or otherwise breaches predetermined acceptance criteria. This way the operator is informed about the weight status of the dust extractor, allowing the operator to take action in case too much weight accumulates at some place in the dust extractor system. Further advantages are obtained if the weight data acquired by the control unit of the dust extractor is communicated to construction equipment that is working together with the dust extractor. The weight data can, for instance, be communicated to a floor grinder where it can be displayed such that an operator is made aware of the current dust generation rate of the floor grinder. The weight data can also be used to optimize operation of the dust generating equipment based on the dust weight data received from the dust extractor, as will be discussed in more detail below. Some types of construction equipment can be controlled to generate more or less dust, e.g., by adapting a processing power of the construction equipment. One example is a shot blaster which can be operated at different power settings, where each power setting generates a respective amount of dust.

The heavy-duty dust extractor may also comprise a dust separator load sensor arranged to measure a torque of the dust separator about a pivot axis of the dust separator relative to the body of the dust extractor, thereby determining a weight of dust held inside the dust separator. This is an alternative or complementary load sensor placement which has the advantage of being distanced from the ground surface to a location where it is not so exposed and also subject to less dirt and mechanical impact. The dust separator load sensor can be realized with advantage using a load cell arranged in connection to a support element distanced from the pivot axis. A torque sensor arranged in connection to the pivot axis can also be used.

According to other aspects, the control unit is arranged to transmit data indicative of the determined dust extraction rate and/or the determined weight of extracted dust to a remote server and/or to construction equipment associated with the dust extractor, such as a concrete processing machine or a remote control device. This allows a number of functions to be implemented at the remote server, as will be discussed below.

The control unit is optionally arranged to determine an expected time instant for preferred emptying of a dust container based on the determined dust extraction rate. This means that an operator can receive information about how long time remains before the operator has to empty the dust container (before it gets too heavy or overflows), allowing the operator to better plan the work task. The operator can receive the information via a display on the dust extractor, via a display on a remote control device, or via a display on the concrete processing equipment that is generating the dust extracted by the dust extractor. The function is particularly suitable for use in autonomous systems, where a robotic dust extractor can be sent off to a dust container emptying station in a timely manner as the dust container gathers enough dust and slurry to merit emptying before the dust container becomes too heavy.

The control unit can furthermore be arranged to determine a suitable choice of concrete processing tool based on the determined dust extraction rate and/or based on a time variation in the determined dust extraction rate. Some tools used for certain work tasks tend to generate a significant amount of dust and slurry initially, whereupon the generated amount of dust then gradually falls off to a smaller value. The dust generation rate of a given tool (inferred from the dust extraction rate of the dust extractor) which has fallen below some threshold, may indicate that it is time to switch to some other tool, such as a finer grinding tool. A dust extraction rate which initially falls off and then becomes stationary over time may also be indicative of a preferred time to change tools, or that a work task is completed. Thus, a more efficient concrete processing operation can be obtained. This function can of course also be implemented by a control unit arranged in the dust generating equipment connected to the dust extractor (which comprises the tool), or in a remote control device connected to the dust extractor and/or to the dust generating equipment via wireless link.

The control unit on the dust extractor, and/or a control unit arranged on associated dust generating construction equipment, can as mentioned above be arranged to control a production rate of construction equipment associated with the dust extractor based on the measured dust extraction rate. The measured extraction rate can, for instance, be compared to a reference rate and the construction equipment operation can be adjusted accordingly to obtain a desired dust production rate. The desired dust extraction rate can, for instance, be set as a rate which the dust extractor can handle efficiently. The desired dust extraction rate can also be set based on computer simulation, numerical analysis and/or practical experimentation related to various efficiency metrics, production quality metrics, and/or tool wear metric, to give a few examples.

The disclosure also relates to construction equipment associated with the dust extractor such as a floor grinder, a concrete wall saw, a power cutter, core drilling equipment, a shaver, a scarifier, a shot blaster, a steel blaster, or a remote control device arranged to control a concrete processing machine and/or the dust extractor. The construction equipment comprises a control unit arranged to communicate with the heavy-duty dust extractor discussed above. The control unit of the construction equipment is arranged to receive data indicative of a weight of extracted dust from the heavy-duty dust extractor and/or data indicative of a dust extraction rate, and to control at least one function of the construction equipment based on the received data. The control unit in the construction equipment may comprise means for measuring time, although this is not necessary.

The construction equipment can for instance comprise a display unit, in which case the at least one function of the construction equipment may comprise displaying, by the display unit, any of; a weight of extracted dust by the dust extractor, a weight of extracted dust supported in a dust container of the dust extractor, a dust extraction rate of the dust extractor, and/or a notification indicating a discrepancy between a current dust extraction rate of the dust extractor and an expected dust extraction rate of the dust extractor. A time variation in dust extraction rate of the dust extractor can of course also be displayed, such as a decrease in dust extraction rate over time.

The construction equipment may also comprise a drive unit such as an electric machine, a hydraulic actuator, or a combustion engine. The control unit of the construction equipment can then be arranged to control an operation of the drive unit based on the received data from the heavy-duty dust extractor, such as to regulate the amount of generated dust by the concrete processing equipment towards some target dust generation value, as mentioned above. The drive unit control may, e.g., comprise control of an applied force, torque, or speed of the tool relative to the work object. This means that the operation of the construction equipment can be conveniently optimized to generate a preferred amount of dust for a given work task, which is neither too high nor too low. The tool contact pressure with respect to the work object and/or the tool motion speed relative to the work object can advantageously be controlled in this manner.

According to some aspects, the construction equipment comprises a variable tool contact pressure arrangement and the control unit is arranged to control a weight or force applied to a concrete processing tool of the construction equipment based on the received data from the heavy-duty dust extractor. This way the tool contact pressure can be adapted based on the dust generation rate to obtain a desired tool behavior, which is an advantage.

According to some other aspects, an operating power of a shot blaster, scarifier, or shaver is adapted based on the received data from the heavy-duty dust extractor to obtain a desired dust generation rate for a given work task.

The control unit of the construction equipment can also be arranged to transmit a signal to the heavy-duty dust extractor comprising an instruction to perform a dust separator emptying operation, for instance in response to a user input (e.g. the push of a button or the selection of a menu option on a display device) and/or in response to that the weight of extracted dust exceeding a predetermined threshold weight and/or in response to that the extraction rate of dust exceeding a predetermined threshold rate.

According to some aspects, the construction equipment is arranged to determine a suitable choice of concrete processing tool based on the dust extraction rate and/or based on a time variation in the dust extraction rate, such as a rate of decrease in the dust generation rate. Some concrete processing operations are associated with a change in dust generation rate as the work tasks progress. The dust extraction rate may, e.g., decline and then level out as the time to change tools approaches. Thus, for some work tasks the dust extraction rate can be used as an indication of when to change tool, which is an advantage. For some work tasks the time variation in the dust extraction rate can be used as indication of when to change tool, which is an advantage. The dust extraction rate and/or the time variation in dust extraction rate can also be used to determine when a work task is nearing completion or is completed.

The construction equipment can also be arranged to control a liquid dispenser of the equipment based on the received data. This way activation and deactivation of a supply of liquid, such as water, to the work object being processed by the equipment can be controlled. The amount of dispensed liquid can also be controlled based on the received data.

There are also disclosed herein control units, methods, and computer programs associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 illustrates an example dust extractor;

FIG. 2 shows example ground support members of a dust extractor;

FIG. 3 illustrates a tilt angle with respect to a horizontal plane;

FIG. 4A-D illustrate a hatch mechanism with a dust container holder;

FIG. 5 illustrates some other details of an example dust extractor;

FIG. 6 shows a load sensor based on dust separator pivoting;

FIG. 7 illustrates a user interface of an example dust extractor;

FIG. 8 is a flow chart illustrating methods;

FIG. 9 schematically illustrates a control unit;

FIG. 10 schematically illustrates a computer program product;

FIG. 11 is a graph illustrating a time variation in dust extraction rate;

FIG. 12 illustrates a dust extractor with an example pre-filter system;

FIG. 13 shows an exemplary pre-filter system;

FIG. 14 shows filter cleaning operations over time; and

FIG. 15 illustrates an exemplary valve arrangement in a dust extractor.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

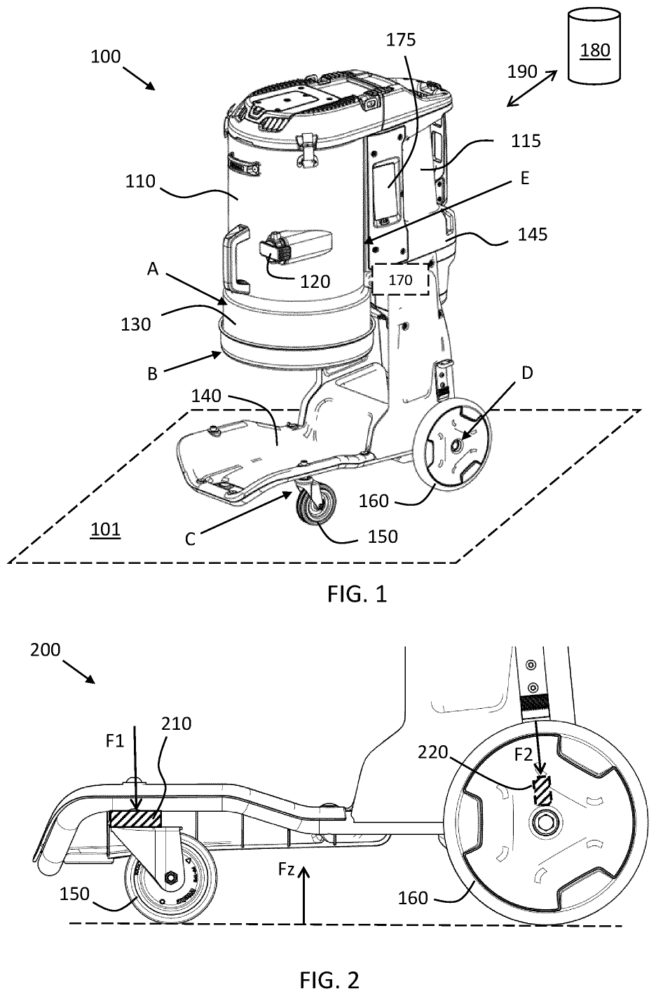

FIG. 1 illustrates an example dust extractor 100. The dust extractor is arranged to extract dust from various concrete processing operations, such as a concrete surface processing operation by a floor grinder, a cutting operation by a concrete wall saw or a power cutter, or a hole sawing operation involving core drilling equipment. Other uses of the dust extractor 100 are of course not excluded, such as general cleaning tasks not involving concrete processing operations. Some dust extractors may also extract wet material, such as slurry, from a concrete processing operation or the like. The techniques disclosed herein are applicable with a wide range of dust extractors, including air cleaners.

The dust extractor generates suction by means of a fan, such as a blower or compressor, which draws dust and slurry into a dust separator 110 (illustrated by a cyclone in FIG. 1) via a hose connection 120, and then past a pre-filter arranged upstream from an essential filter which captures the finer dust particles. A dust separator or dust separator is, generally, an arrangement which separates dust particles from a stream of air. A dust separator is often arranged upstream from an essential filter and can comprise a cyclone as well as one or more pre-filters (i.e., filter coarser than the essential filter). Other forms of dust separators are also possible, such as pure filter-based dust separators which do not comprise a cyclone. It is noted that both the pre-filter and the essential filter are optional, and that the techniques disclosed herein can be applied also in dust extractors which only comprises a cyclone (without filters), and in dust extractors where one or more filters are arranged in an entity separated from the cyclone, for instance connected via hose to the cyclone unit.

Essential filters are discussed in, e.g., International Electrotechnical Commission (IEC) standard 60335-2-69:2021, annex AA.

The dust separator 110 is supported by the main body 145 of the dust extractor 100, which comprises a carrier structure 140 to support, e.g., a plastic bag dust container. Some dust extractors may comprise additional body structures for supporting a pre-filter, and/or or supporting an essential filter. The techniques disclosed herein are appliable also with such multi-body dust extraction arrangements.

A dust container holder 130 is arranged to support a dust container, such as a plastic bag or a bucket (not shown in FIG. 1). A so-called Longopac system dust container is often used, which is a type of long plastic tubular container which is fed out from the dust container holder in sections to hold portions of dust. Slurry, i.e., wet concrete waste material, may also be collected in this manner, although pure dust extractors are more common.

The dust container may in some cases be supported by the carrier structure 140, and in other cases suspended from the dust container holder 130. A separating structure such as a hatch mechanism, grate, or collapsible cone, normally separates the dust separator interior from the dust container during operation. The term separating structure is to be construed broadly herein to encompass any structure which separates the dust separator interior from the dust container. The function of the separating structure is to prevent the dust container from being sucked into the dust separator during operation. In cases where a rigid dust container is used, such as a bucket, there may not be any separating structure in between dust separator and dust container. The present disclosure is not limited to any particular form of hatch mechanism or other separating structure.

The dust separator 110 can be periodically emptied into the dust container by backflushing the system in a known manner, or by turning off the dust extractor to release the suction underpressure, whereby the dust is evacuated from the dust separator into the dust container. The emptying operation of the dust separator 110 may involve the hatch mechanism opening to evacuate dust and slurry from the interior of the dust separator. A hatch is an example of a separating structure arranged between a dust separator and a dust container. A hatch mechanism may have a dust separator side facing into the dust separator and a dust container side facing into the dust container. Thus, during backflushing and sometimes also spontaneously, the hatch mechanism opens up and the dust and slurry inside the dust separator 110 falls down into the dust container. When the dust container is full it needs to be emptied by an operator. It is generally desired to not fill the dust container with too much dust and slurry since the dust container then becomes heavy and more difficult to handle manually by the operator.

According to some aspects of the teachings herein, the mechanism for evacuating dust and slurry from the dust separator 110 and into the dust container is triggered by the control unit based at least partly on how much dust and slurry that is held inside the dust separator. The amount of dust and slurry inside the dust separator can be determined or at least estimated by the control unit, based on the data from the different weight sensors disclosed herein.

The dust extractor 100 is supported on the ground surface 101 by one or more support members 150, 160, in this case two front wheels 150 and two rear wheels 160 attached to the carrier structure 140. These wheels allow the dust extractor to be transported in a convenient manner. Other types of support members are also possible, such as rubber feet. Three separate support members (feet and/or wheels) normally provide a stable enough ground support, although some dust extractors may be supported by a single support member having an extension in the horizontal plane sufficient to support the dust extractor 100 in a stable manner.

When using a dust generating concrete processing tool such as a floor grinder, a way of measuring the effectiveness/productivity of the work task is by measuring how many kilograms (kg) of dust and slurry that is produced in a given amount of time, i.e., the dust production rate. An experienced operator can estimate the dust production rate from observing the filling of the dust container over time, normally as the dust container is emptied, and decide if the correct type of tool is being used based on the dust production rate of the dust generating construction equipment. In other words, the experienced operator uses the dust extraction rate of the dust extractor to infer the dust generation rate of the dust generating equipment. For instance, when using a coarse grinding tool, the dust generation rate is expected to be significant. Hence, if no dust at all or only a very little dust is generated when using the coarse grinding tool, then something is most likely wrong. This way of working is rather difficult and requires an experienced operator in order to accurately determine the dust generation rate. The dust generation rate also takes some time to determine by visual inspection of the dust container alone, e.g., 10-15 minutes or so.

The dust extractor 100 in FIG. 1 is equipped with one or more load sensors arranged to measure the weight of the dust extracted by the dust extractor. The dust extractor 100 also comprises a control unit 170 which comprises means for measuring time, such as a timer or a clock. Thus, a dust extraction rate of the dust extractor in terms of the weight of extracted dust per unit of time, e.g., kg/min or kg/h, can be determined by the control unit 170. The control unit 170 can be arranged to control various functions and operations of the dust extractor, such as to display information on a display device 175 of the dust extractor, to control a fan power setting of the dust extractor, and also to transmit and receive signals to and from external entities such as construction equipment, remote display devices, and remote servers 180.

As will be explained in the following, with reference to FIG. 1, load sensors can be arranged in connection to the hatch mechanism, more generally the separating structure, at the bottom of the dust separator (A) to measure a load exerted by extracted dust and slurry on the separating structure, in connection to the dust container holder (B) to measure a load of dust accumulated in the dust collector, in connection to one or more support members (C, D) of the dust extractor, and also as a pivot sensor arranged in connection to the dust separator. Tyre pressure monitoring sensors arranged inside tyres on support members can also be used to obtain data related to current load on a given wheel.

FIG. 2 illustrates details of an example dust extractor 200 which comprises load sensors 210, 220 arranged in connection to the front and rear supporting wheels 150, 160. It is appreciated that all of these load sensors are not required, it is sufficient with a single load sensor, as will be explained in the following. However, using four (or more) load sensors of course provides more stable data upon which the dust extraction rate can be determined.

The control unit 170 is arranged to receive data indicative of the load F1, F2 measured by the at least one load sensor on the dust extractor, and to determine a dust extraction rate in terms of the weight of extracted dust per unit of time based on the received data, based on the timer or clock comprised in the control unit or at least accessible from the control unit. The control unit may then control an operation of the heavy-duty dust extractor 100 based on the determined dust extraction rate. Determining a dust extraction rate in terms of the weight of extracted dust per unit of time can be done in many ways. One way is to simply calculate the weight of dust, e.g., in kilograms, that is extracted unit of time, e.g., per minute or hour, and thus determine the rate in units of kg/min or kg/h. Another way is to relate the determined weight and time period to a unitless scale, say from 1-10, where 1 is a small extraction rate and 10 is a high extraction rate. A third example of determining a dust extraction rate in terms of the weight of extracted dust per unit of time is to determine the rate in relation to some reference rate. The dust extraction rate can then be given as a percentage relative to the reference rate, for example 10% below nominal rate or 10% above nominal rate. Thus, it is appreciated that a dust extraction rate determined in terms of the weight of extracted dust per unit of time is to be construed broadly herein to encompass all forms of dust extraction rate metrics.

An increase in accumulated dust and slurry weight can be determined by integrating dust extraction rate over a time period. An amount of dust and slurry inside the dust separator 110 can thus be determined, or at least approximated, by integrating dust extraction rate over a time period from when dust held inside the dust separator was last evacuated into the dust container.

If the determined dust extraction rate is not in line with an expected dust generation rate given the current concrete processing operation and potentially also given the current tool choice, then a notification may be issued to inform a user of the fact. The control unit 170 may also inactivate the dust extractor in case the dust extraction rate deviates from an expected dust extraction rate configured in dependence of a current concrete processing operation. Some dust extractors may also be connected via wireless or wired link to the construction equipment that is generating the dust and slurry. In this case the control unit 170 may also transmit data to the concrete processing equipment related to the dust extraction rate, whereupon the concrete processing equipment may adjust its operation in dependence of the data. Some types of construction equipment may for instance inactivate themselves in case an unexpected amount of dust (insufficient or excessive) is extracted. This feature can improve safety at the construction site since an insufficient dust extraction rate may be indicative of malfunction in the dust and slurry extraction system, i.e., that part of the generated dust is released into the air where it can harm personnel at the site. An unexpectedly low dust extraction rate may also be indicative of an unexpectedly low dust generation rate by the dust generating equipment connected to the dust extractor. The dust generating equipment may, e.g., have a malfunctioning concrete processing tool which is no longer efficiently processing the concrete, or a damaged housing or dust shroud that allows dust to escape into the ambient environment before it can be captured by the dust extractor. Glazing of a tool on the dust generating equipment may be detected or even predicted before it happens in this manner, since glazing normally results in a significant decrease in dust generation rate. By inactivating the dust generation equipment and/or triggering an indication to an operator of the fact, the operator can investigate why the measured dust extraction rate is not in line with the expected dust extraction rate, thereby avoiding that harmful dust is released into the atmosphere at the construction site or that concrete processing is performed in an inefficient manner due to malfunctioning concrete processing equipment.

Some of the dust extractors disclosed herein may also be capable of controlling a rate of a concrete processing operation by construction equipment, such as a shot blaster or shaver, in order to obtain a desired dust generation rate by the construction equipment. The control unit 170 may, for instance, transmit control signals over a wireless interface to the construction equipment in order to increase or decrease the production rate of the construction equipment.

To summarize, various applications and functions can be implemented based on the control unit arranged to determine dust extraction rate. Some examples of such applications comprise displaying the determined dust extraction rate on a display device 175 on the dust extractor and/or on a display device 700 remote from the dust extractor, and also comparing the determined dust extraction rate to one or more predetermined thresholds and triggering a notification function to notify a user in case the dust extraction rate exceeds an upper threshold and/or falls short of a lower threshold.

The control unit can also be arranged to configure a fan power setting of the dust extractor based on the determined dust extraction rate. This way the fan power can be increased if the dust generation rate is high and decreased otherwise. A decreased power setting leads to a decrease in power consumption, which may be desired, particularly if the dust extractor is battery powered. Fan setting dependent reference dust extraction rates can be configured and used as basis for the fan power control by the control unit. It is appreciated that a reduced fan power setting normally also leads to a reduction in dust extraction rate, hence, the reference dust extraction rates are preferably configured as function of the current fan power setting. For instance, a table of fan power settings with respective upper and lower dust extraction rate thresholds can be configured. If the dust extraction rate at a current fan power setting goes above the tabulated reference value by some margin, then the fan power can be increased. If the dust extraction rate at the current fan power setting falls short of the tabulated reference value by some margin then the fan power can be reduced. These reference dust extraction rates to be used for fan control can be determined by experimentation or by computer simulation and pre-configured in the control unit. They can also be manually configured or at least adjusted by an operator.

The control unit may also be arranged to determine a time variation in dust extraction rate, as illustrated in FIG. 11, e.g., as an average time derivative of the dust extraction rate computed over some time period, such as a few minutes or so. This time variation in dust extraction rate has units of kg/s². The control unit can then compare the determined time variation in dust extraction rate to one or more predetermined thresholds or reference values, and to trigger an operation of the dust extractor in case the time variation in dust extraction rate exceeds an upper threshold and/or falls short of a lower threshold and/or deviates too much from a reference value. The reason for this function is that some concrete processing operations exhibit a characteristic behavior where the rate is initially high and then falls off. When the dust extraction rate falls off (as illustrated in FIG. 11) and becomes stationary, it is often time to change concrete processing tools. A stationary dust extraction rate, i.e., one which does have a significant time variation, may also be indicative of work task completion.

There is disclosed herein a heavy-duty dust extractor 100, 200, 300, 400, 500, 600 comprising a dust separator 110 such as a cyclone or coarse filter, wherein the heavy-duty dust extractor 100 is arranged to be supported on a ground surface 101 by one or more support members 150, 160, where one or more load sensors 210, 220 are arranged in connection to the one or more support members 150, 160 to measure a load on at least one support member 150, 160. The dust extractor comprises a control unit 170, 900 arranged to receive data indicative of the load measured by the one or more load sensors 210, 220, where the control unit 170, 900 comprises means for measuring time. The control unit 170, 900 is arranged to determine a time variation in dust extraction rate in terms of a weight of extracted dust per unit of time squared based on the received data, and to control an operation of the heavy-duty dust extractor 100 based on the determined dust extraction rate.

An example realization 900 of the control unit 170 will be discussed below in connection to FIG. 9. This control unit 900 can also be arranged in dust generating construction equipment, as well as in remote control devices, and portable display units such as tablets and smart phones.

The load sensors 210, 220 discussed herein may comprise one or more load cells arranged to generate an electrical signal based on a tension, compression, pressure, or torque exerted by the ground surface 101 on the support member 150, 160. Load cells are generally known and will therefore not be discussed in more detail herein.

According to a preferred embodiment, as illustrated in FIG. 1 and in FIG. 2, the dust extractor comprises four wheels constituting the support members 150, 160 to stably support the dust extractor on the ground surface 101. A load sensor 210, 220 can be arranged in connection to one or more of the wheels. A load sensor may, for instance, be arranged about a vertical axle of a swiveling front wheel 150 of the dust extractor to measure a load F1. A load sensor 220 can also be arranged to measure a load F2 on at least one of the rear wheels 160 or a load on an axle connecting the two rear wheels 160, as a complement or as a stand-alone sensor. It is an advantage if the support members are flexible enough to absorb unevenness in the ground.

As illustrated in FIG. 2, the measured load F1, F2 by a load sensor is indicative of a normal force Fz (schematically illustrated in FIG. 2) exerted by the ground surface 101 on the support member 150, 160 to which the load sensor is associated. It is appreciated that the total weight of the dust extractor 100 is distributed over the support members, i.e., if there are N support members, and the total weight of the dust extractor 100 is W, then

$$W = {\sum }_{i = 1}^{N} {w}_{i}$$

where wᵢ is the weight on the i-th support member. This weight distribution is not always even but can often be determined by simulation or experimentation beforehand and tabulated in a memory of the control unit. Hence, a single load sensor measuring only one of the weights {wᵢ}_{i=1 . . . N} is often sufficient in order to determine both the total weight W of the dust extractor, and the weight of the accumulated dust and slurry by the dust extractor 100 by subtracting a pre-configured unloaded dust extractor weight W₀ from W. The dust extraction rate \dot{W} can be determined as the change in the weight of extracted dust and slurry W−W₀ for a given period of time T. In other words, according to an example, the dust extraction rate W can be determined as

$$\dot{W} = \frac{W ( {t}_{2} ) - W ( {t}_{1} )}{{t}_{2} - {t}_{1}}$$

where t₁ and t₂ are the time instants when the load sensor data was received by the control unit 170.

According to some aspects, the heavy-duty dust extractor comprises an inertial measurement unit (IMU). An IMU is a device which measures acceleration and vibration, and it can be used by the control unit 170 to determine if the dust extractor 100 is stationary (not moving) or subject to some form of motion. An operator may, for instance, shake the dust extractor as a hose is attached to the connection 120. The dust extractor 100 may also vibrate if it is being re-located on a non-smooth ground surface 101. During periods when the dust extractor is not reasonably stationary, it is unlikely that the load data received by the control unit from the one or more load sensors is reliable. Consequently, the control unit 170, 900 can be arranged to process the data indicative of the load measured by the load sensor 210, 220, conditioned on that the IMU outputs a signal indicative of dust extractor stationarity. This means that the control unit 170, 900 monitors the output from the IMU and determines if the dust extractor 100 is sufficiently stationary for the load sensors to provide relevant output data, or if the dust extractor is not stationary enough to use the data from the one or more load sensors. The test for sufficient dust extractor stationarity may involve comparing an average acceleration or magnitude of vibration to an acceptance criterion, such as a predetermined threshold or range of acceptable output values from the IMU. The predetermined threshold or range of acceptable output values from the IMU can be determined beforehand by experimentation or by mathematical analysis involving, e.g., computer simulation.

The control unit 170, 900 is preferably also arranged to determine the dust extraction rate and/or the weight of extracted dust by averaging the data indicative of the load measured by the load sensor 210, 220. This averaging may comprise, e.g., lowpass filtering or application of a moving average filter which suppresses transient disturbances on the load data due to, e.g., vibration and the like. This lowpass filtering or moving average filtering can also be determined beforehand by experimentation or by mathematical analysis involving, e.g., computer simulation. More advanced signal processing operations can of course also be applied, such as Kalman filtering. A Kalman filter uses a model of the dust extractor (which can be determined beforehand) to filter the data received from the load sensor or sensors. Kalman filters are generally known and will therefore not be discussed in more detail herein.

If the control unit has access to data from an IMU, then the control unit 170, 900 may also be arranged to process the load data at least partly based on the signal from the IMU. For example, the control unit may apply some type of weighted filtering, where load data from sensors received during periods when the dust extractor is stationary, i.e., not moving or vibrating significantly is given more weight compared to load data from the one or more load sensors which is received during periods when the dust extractor is not stationary, i.e., is vibrating significantly or being re-located. This way load data which is measured during periods of disturbance due to vibration or movement of the dust extractor is suppressed in favor of load data which is measured when the dust extractor is stationary, i.e., not being moved around or vibrating excessively.

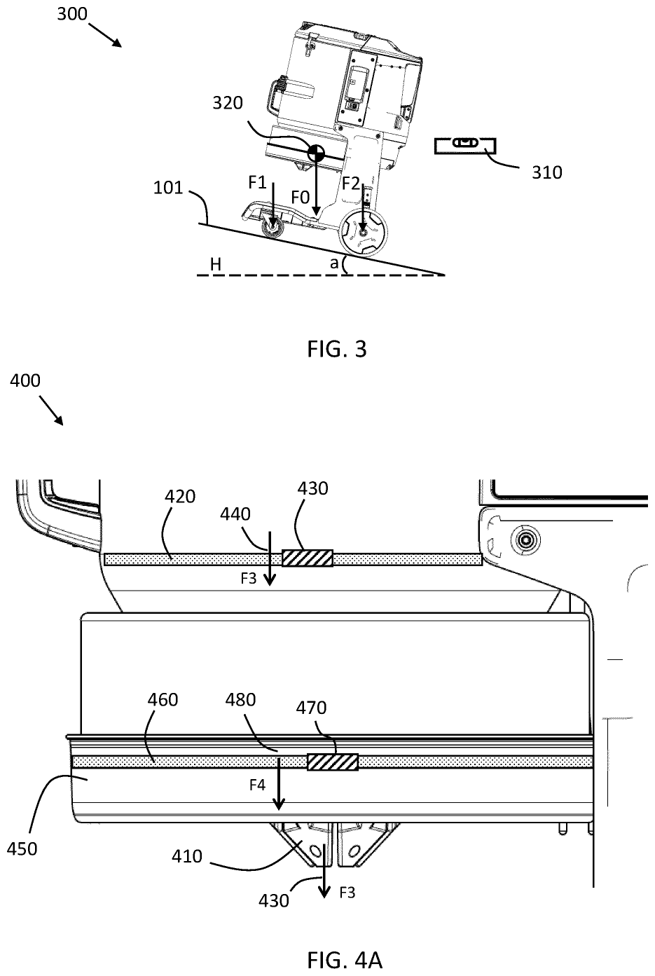

With reference to FIG. 3, the heavy-duty dust extractor 300 may also comprise an electronic spirit level 310 arranged to determine at least an angle a of the ground surface 101 relative to a horizontal plane H. The control unit 170, 900 can then be arranged to compensate the data indicative of the load measured by the load sensor 210, 220 based on the angle a. The weight distribution over the support members is a function of the angle a. The more the dust extractor in the example 300 of FIG. 3 is tilted rearwards, the more weight falls on the rear wheels, and the more the dust extractor is tilted forward, the more weight falls on the front wheels. Weight may also be unevenly distributed over the two sides of the device. By obtaining data indicative of this angle a, the control unit 170 is able to compensate for tilt, which is an advantage since the load data then becomes more reliable, especially if a single load sensor is used, e.g., in connection to the front wheel. The control unit 170 may be configured with an analytic function which is used to perform this compensation based on the angle a, or just a look-up table with compensation factors stored in memory and indexed by the angle a relative to the horizontal plane H or to some other reference plane. The center of mass 320 of the dust extractor may be used as an input to the control unit 170. The electronic spirit level 310 is preferably a two-dimensional (2D) or three-dimensional (3D) electronic spirit level, which measures a relation between a plane tangent to the support members and the horizontal plane H. This 2D electronic spirit level then provides data on sideways tilt as well as tilt in the front/rear direction. A straightforward way of estimating the total weight W of the dust extractor based on a single measurement of load on a single support member is to tabulate estimated total weights as function of the load measurement and the output from the electronic spirit level and store this table in a memory of the control unit 170. A mathematical relationship can also be configured by the control unit 170 to perform this mapping from load sensor data and electronic spirit level output to total weight W of the dust extractor.

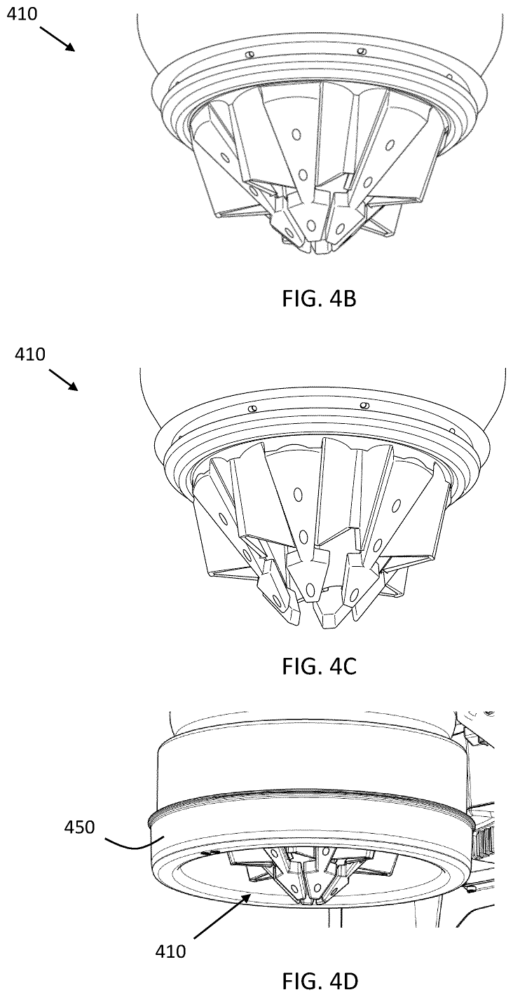

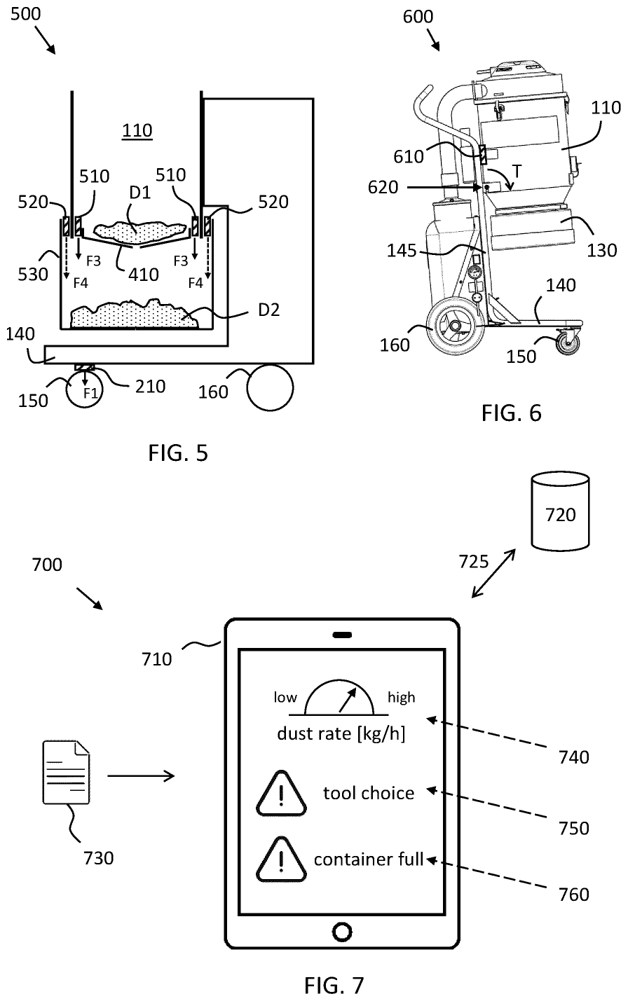

FIGS. 4A-D and FIG. 5 illustrate details 400 of a combined hatch mechanism 410 and dust container holder 450. The hatch mechanism is an example of a separating structure which separates the dust separator interior from the dust container of the dust extractor. According to this example, the hatch mechanism 410 is suspended from the dust extractor main body (which in turn is supported on the ground surface by the support members) by a resilient portion 420 which is compressible and/or extendible in the vertical direction (the direction of gravity). Thus, a load sensor 430 can be arranged in connection to the resilient portion 420 to measure 440 a load F3 exerted on the hatch by the accumulated dust and slurry inside the dust separator 110, at least approximately.

FIG. 4B illustrates an example hatch mechanism in closed position, where dust and slurry are accumulated above the hatch (in direction away from the supporting surface 101). FIG. 4C illustrates the same hatch mechanism 410 in open position, in which position dust and slurry may fall from the dust separator interior and into the dust container arranged under the hatch.

FIG. 4D shows how a dust container holder 450 can be arranged in combination with a hatch mechanism.

It has been realized that by arranging a plurality of load sensors at key places on the dust extractor, it becomes possible to measure a weight of accumulated dust at different places in the dust extractor, forming part of the total weight W of the dust extractor. Places of interest, where dust and slurry accumulate during the dust extraction operation, includes above the hatch (inside the cyclone), below the hatch in the dust container suspended from the dust container holder, and also supported on the carrier structure 140 (such as if the dust container is resting on the carrier structure 140). The load sensors 210, 220 arranged in connection to the support members measure a total weight of the dust extractor 100, regardless of the location of the dust and slurry. Some of the total weight is supported by the hatch, some of the total weight is supported by the dust container, and some of the total weight is supported by the carrier structure 140. By arranging load sensors in key places, as illustrated in FIG. 5, these weight portions can be determined.

FIG. 4 and FIG. 5 illustrate details of example dust extractors where a separating structure load sensor 430, 510 is arranged to measure a weight of dust and slurry supported by the separating structure (such as a hatch, grate, or collapsible cone). The dust container load sensor 470, 520 is configured to measure the weight of dust and slurry in the dust container, in addition to the load sensor 210 arranged in connection to the support member 150.

The separating structure load sensor 430, 510 can be realized by a load cell arranged to measure a vertical displacement of the hatch supporting structure relative to the main body 145. In case the hatch is made in a resilient material like rubber, then a load cell can be arranged between the main body 145 and a location on the hatch to measure a stretch of the hatch due to accumulated weight of dust and slurry on the dust separator side of the hatch. The dust container load sensor 470, 520 can also be realized using a load cell. Some form of resilient mounting member can be arranged in-between the dust container holder and the main body 145 of the dust extractor. An accumulated weight of dust and slurry in the dust container then exerts a pulling force on the dust container holder, which the load cell registers and transmits to the control unit 170 as the load data.

To summarize, examples of the heavy-duty dust extractor 400, 500, discussed herein comprises a separating structure load sensor such as a hatch load sensor 430, 510 arranged to measure a load F3 exerted on a hatch mechanism 410 of the dust extractor and the control unit 170, 900 is arranged to receive data indicative of the load measured by the hatch load sensor 430, 510. The control unit is also arranged to determine a weight of dust supported by the hatch mechanism 410, based on the data indicative of the load measured by the hatch load sensor 430, 510. The heavy-duty dust extractor 400, 500 may also comprise a dust container load sensor 470, 520 arranged to measure a load F4 exerted on a dust container 530 of the dust extractor. In this case the control unit 170, 900 is arranged to receive data indicative of the load measured by the dust container load sensor 470, 520, and to determine a weight of dust supported by the dust container 530, based on the data indicative of the load measured by the dust container load sensor 470, 520. Suppose for instance that the dust extractor comprises load sensors that measure loads W_{hatch}, W_{container}, and Wₛᵤₚₚₒᵣₜ, where W_{hatch} is related to F3, W_{container} is related to F4 and Wₛᵤₚₚₒᵣₜ is a measure of the total weight W of the dust extractor. Then W_{hatch} can be used to detect when the hatch dump function of the dust extractor does not work satisfactorily, i.e., that more than an acceptable amount of dust accumulates on top of the hatch without being evacuated into the dust container. The magnitude of W_{container}, can be used to detect when the dust container has reached its capacity and needs to be emptied, while Wₛᵤₚₚₒᵣₜ provides an indication of the total weight of the dust extractor. This total weight of the dust extractor may be important to monitor in case the surface is sensitive, such as if the surface is relatively recently poured concrete which has not yet fully matured. A too heavy dust extractor may then leave marks on the surface, which of course is undesired.

According to some aspects, the control unit 170 is arranged to indicate one or more of the weights W_{hatch}, W_{container}, and Wₛᵤₚₚₒᵣₜ to an operator via a display or remote device. The operator can then determine, e.g., if the dust extractor total weight W exceeds an acceptance criterion for weight to be supported by the ground surface 101, if the amount of dust accumulated above the hatch is acceptable, and also what the current weight of accumulated dust and slurry in the dust container is, such that the dust container can be emptied in time before it becomes too heavy to be handled manually in a convenient manner. Some of these function will be discussed in more detail below in connection to FIG. 7. To summarize, the control unit 170, 900 may be arranged to trigger activation of a notification function of the dust extractor in case the weight of dust supported by the hatch mechanism 410 or the weight of dust supported by the dust container 530 exceeds respective weight thresholds. This function could for instance be useful in order not to overfill a dust container, making it too heavy to handle manually by an operator. The weight threshold can, e.g., be configured in dependence of dust container type, and/or in dependence of the type of dust extractor. The control unit 170, 900 may also be arranged to trigger transmission of a wireless or wired signal to associated construction equipment in case the weight of dust supported by the hatch mechanism 410 or the weight of dust supported by the dust container 530 exceeds the respective weight thresholds. Dust generating equipment can thus be inactivated, i.e., placed in stand-by mode of operation, until the dust extractor has been serviced and once more placed in a fully operational condition to extract dust from the dust generating equipment.

It is appreciated that both the separating structure load sensor 430, 510 and the dust container load sensor 470, 520 can be used as stand-alone load sensors in a system together with the control unit 170, i.e., neither the separating structure load sensor 430, 510 nor the dust container load sensor 470, 520 require any of the other load sensor systems discussed herein. The various applications and functions based on the load data from the sensors discussed herein can also be implemented together with the separating structure load sensor 430, 510 or the dust container load sensor 470, 520.

FIG. 6 illustrates a dust extractor 600 with another example load sensor arrangement. The dust separator 110 is here pivotably supported by the main body 145 by a protrusion or tap upon which the dust separator rests. The dust separator 110 may, as seen, e.g., in FIG. 1, be arranged to at least indirectly support both hatch mechanism and dust container. This added weight will generate a pivoting force, or torque T, about the mounting point 620. A load sensor can be configured to measure this torque T about the pivoting point 620. In other words, the heavy-duty dust extractor 600 optionally comprises a dust separator load sensor 610 arranged to measure a torque T of the dust separator 110 about a pivot axis 620 of the dust separator relative to a main body 145 of the dust extractor. This type of load sensor arrangement can be used as a stand-alone load sensor or in combination with the different load sensor arrangements discussed above.

It is appreciated that the dust separator load sensor 610 can also be used as a stand-alone load sensor in a system together with the control unit 170, i.e., the dust separator load sensor 610 can be used as an only sensor in a system to realize the various applications and functions based on the load data from the sensor discussed herein.

With reference to, e.g., FIG. 5, the dust and slurry D1 accumulated in the dust separator 110 is periodically emptied into the dust container 530, where it accumulates D2. It is undesired to perform the emptying operation, where dust and slurry at D1 held inside in the dust separator 110 is moved to the dust container D2, since this emptying operation normally involves reconfiguration of the suction operation, e.g., by opening valves to atmospheric pressure, closing valve to the suction inlet, or the like, which temporarily reduces dust extraction performance. At the same time, it is also undesired to perform the emptying operation too seldom since then too much dust and slurry may accumulate inside the dust separator 110, whereupon the amount of dust D1 may become too large such that emptying becomes more difficult. According to some aspects, the control unit 170 is configured to measure the weight of dust and slurry D1 accumulated in the dust separator 110 and control a dust separator evacuation operation based on the determined weight. The measured weight can be compared to a reference weight for emptying the dust and slurry into the dust container. The reference weight can be configured as a function of the dust material, the moisture of the dust and slurry, and in dependence of the type of dust extractor in use. The dust material can be configured manually by a user or set automatically, e.g., as a function of the tool used by a dust generating machine. The moisture level of the accumulated dust and slurry can be determined automatically by a moisture sensor arranged on the dust extractor or configured manually by an operator. The type of dust extractor may be known to the control unit 170 a-priori or configured manually by an operator. Exact parameter values for triggering emptying operations can be determined by practical experimentation, and/or by computer simulation.

To summarize, the present disclosure relates at least in part to a heavy-duty dust extractor 100, 200, 300, 400, 500, 600 comprising a dust separator 110, one or more load sensors 210, 220, 510, 520, 610, and a control unit 170, 900. The one or more load sensors 210, 220, 510, 520, 610 are arranged to measure a weight of accumulated dust and slurry in the dust extractor D1, D2. The control unit 170 is arranged to receive data indicative of the load measured by the one or more load sensors 210, 220, and to determine a weight of dust D1 inside the dust separator 110. The control unit 170 is also arranged to trigger an emptying operation for evacuating dust and slurry from the dust separator and into a dust container 530 based on the determined weight of dust D1 inside the dust separator 110, as discussed above.

The separating structure on a dust extractor separates a dust separator such as a cyclone tank or coarse filter arrangement from a dust container such as a Longopac bag or bucket that is positioned below the dust separator. Dust and slurry is periodically evacuated from the dust separator into the dust container by actuating the separating structure in some way, e.g., by opening a hatch or controlling valves to trigger an emptying operation where dust falls from the dust separator into a dust container under the dust separator. The emptying operation normally comprises increases the air pressure in the dust separator, e.g., by means of a valve arrangement connecting an ambient environment of the dust extractor to the inside of the dust separator. An emptying operation is an operation to be construed broadly herein. An emptying operation may comprise any of controlling a valve to guide a flow of air backwards through a pre-filter system of the dust separator away from the fan, controlling a valve to guide a flow of air from an external ambient environment into the dust separator, opening a connection to a pressurized gas source, and/or opening a separating structure such as a hatch mechanism, grate, or collapsible cone, to evacuate the dust and/or slurry from the dust separator into the dust container.

It is appreciated that the load on this separating structure can be determined as an amount of dust and slurry accumulated by the dust extractor since the last time the dust separator was emptied into the dust container. In other words, the amount of dust and slurry inside the dust separator can be determined by integrating the dust extraction rate from an approximate time instant when the last emptying operation was performed until a current time instant. Thus, a support member based load sensor can be used also to identify the weight of dust accumulated in the dust separator. Other solutions for determining how much dust and slurry that is held inside the dust separator will be discussed below. It is advantageous to control the emptying operations of a dust extractor based on the amount of dust held inside the dust separator. Thus, some of the control units discussed herein are configured to trigger dust separator emptying operations based on a determined amount of dust and slurry held inside the dust separator. In other words, as will be discussed in more detail below, the control unit may, according to some aspects, control a dust separator emptying operation of the dust extractor based on a determined amount of accumulated dust and slurry accumulated inside the dust separator. The control unit can, for instance, keep track of how much dust and slurry has accumulated inside the dust separator, and determine suitable time instants for evacuating this dust and slurry into the dust container. This way emptying of the dust separator into the dust container below can be performed at intervals which are neither of too short time duration nor of too long time duration.

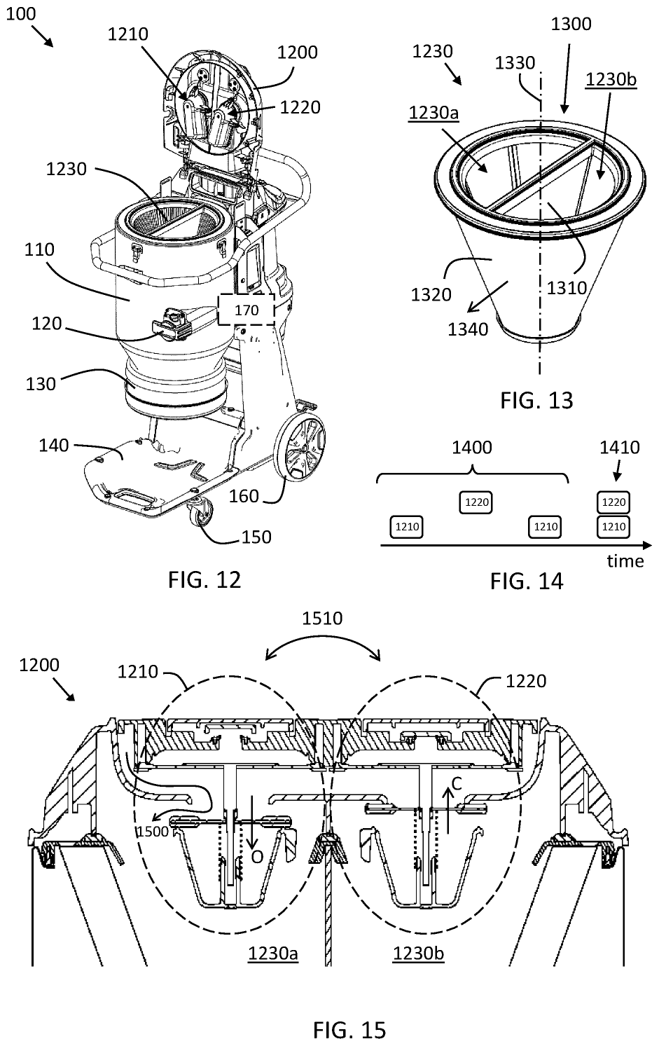

FIG. 12 illustrates an example dust extractor 100 that comprises a dust separator 110 with a lid 1200 that comprises valves 1210, 1220 arranged to generate reverse thrusts of air through a pre-filter system 1230, i.e., backflushing of the filter system. A reverse thrust of air through a pre-filter system is a thrust of air which goes in opposite direction through the filter wall of the pre-filter system compared to the airflow during regular operation of the dust extractor. The reverse thrust of air thus goes in a direction away from the fan of the dust extractor, as indicated by the arrow 1340 in FIG. 13.

FIG. 13 shows an example pre-filter system 1230. This pre-filter system 1230 comprises a pre-filter with a filter aperture 1300 and a filter side wall 1320. The side wall 1320 is arranged to permit a flow of air to pass the side wall and to prevent at least some particulate matter from passing the side wall. The regular flow of air during normal operation of the dust extractor goes through the side wall from its outside to the inside of the filter volume and then up through the filter aperture 1300. The reverse thrust of air generated during filter cleaning goes in the opposite direction, i.e., from the inside of the filter to the outside, as indicated by the arrow 1340 in FIG. 13. The filter side wall 1320, in this example, extends away from the filter aperture 1300 and tapers inwards towards a center axis 1330 of the filter to define a filter interior volume. The pre-filter is arranged to hold a separating wall 1310 in position in the filter interior volume to divide the filter interior volume into first and second parts 1230a, 1230b.

It is appreciated that the pre-filter cleaning techniques and the dust separator emptying operations discussed herein are applicable to pre-filter systems with dividing walls such as the example in FIG. 13, and also to dust extractors comprising two separate pre-filters constituting the first and second parts 1230a, 1230b.

FIG. 15 illustrates a filter cleaning system with a first and a second valve 1210, 1220. Each valve 1210, 1220 can be opened O and closed C to generate a reverse thrust of air 1500, through a respective filter part. The thrust of air is an air flow from an external ambient environment into the dust extractor and out through the filter side wall 1320, as indicated by the arrow 1340 in FIG. 13. Each valve 1210, 1220 can be actuated by a control signal from the control unit 170. During normal dust extractor operation, the control unit actuates the valves 1210, 1220 one after the other 1510 such that the first and second parts 1230a, 1230b are cleaned one after the other in sequence. This mode of filter cleaning maintains suction performance, since one filter part is always used for dust extraction while the other filter part is being cleaned from dust and debris stuck to the filter wall 1320. However, a particularly strong filter cleaning effect is obtained if the first and second parts 1230a, 1230b are cleaned with at least some time overlap, or even simultaneously, by actuation of the valves 1210, 1220. Such actuation by the control unit 170 of the valves 1210, 1220 is likely to result in that the separating structure 410 between dust separator 110 and dust container 530 is opened to evacuate dust and/or slurry from the dust separator into the dust container below, i.e., an emptying operation of the dust separator.

FIG. 14 illustrates valve arrangement operations, where the first and second valves 1210, 1220 are first actuated one after the other 1400, and then with time overlap 1410 to trigger an emptying operation where dust and/or slurry is evacuated from the dust separator and into the dust container.

It has been realized that the actuation of the valve arrangements used for filter cleaning on a heavy-duty dust extractor, such as the valves 1210, 1220, can be actuated by the control unit 170 based on the weight of dust accumulated in the dust extractor and/or based on the weight accumulation rate (i.e., the dust extraction rate). The actuation can for instance be controlled based on the dust extraction rate such that filter cleaning is performed more often when the dust extraction rate decreases. The valve arrangements can also be actuated to perform an emptying operation of the dust extractor 110, where dust is evacuated into the dust container, in case the weight of dust and/or slurry in the dust separator 110 exceeds a threshold or fails to satisfy some other acceptance criterion, such as an allowable range of dust weight in the dust separator 110.

To summarize, there is disclosed a heavy-duty dust extractor 100, 200, 300, 400, 500, 600 comprising one or more load sensors 210, 220, 510, 520, 610, as discussed above, a control unit 170, 900, at least one valve arrangement 1210, 1220 and a dust separator 110 with a pre-filter system 1230, as exemplified in FIGS. 12-15. The at least one valve arrangement 1210, 1220 is configured to generate a reverse thrust of air 1340 through the pre-filter system 1230 upon actuation by the control unit 170, 900. The one or more load sensors 210, 220, 510, 520, 610 are arranged to measure a weight of accumulated dust and/or slurry in the dust extractor D1, D2, such as an absolute weight or a dust extraction rate. The control unit 170, 900 is arranged to receive data indicative of the weight of accumulated dust and/or slurry in the dust extractor D1, D2, and to actuate the at least one valve arrangement 1210, 1220 based on the weight.

According to some aspects, the control unit 170, 900 is arranged to determine a dust extraction rate 740 in terms of a weight of extracted dust per unit of time based on the received data, and to configure an actuation frequency of the at least one valve arrangement 1210, 1220 based on the dust extraction rate 740.

A reduction in dust extraction rate can, for instance, result in more frequent filter cleaning by a more frequency generation of reverse thrusts of air 1500. A reverse thrust of air can also be generated every time a given amount of dust has been extracted by the dust extractor, as indicated by the load sensors. In this case the control unit keeps track of how much dust that has been extracted since the last filter cleaning operation and triggers a reverse thrust of air once a predetermined amount of extracted dust has been reached since the last filter cleaning operation.

The heavy-duty dust extractor 100, 200, 300, 400, 500, preferably comprises at least a first and a second valve arrangement 1210, 1220, as exemplified in FIG. 14, and the pre-filter system 1230 comprises at least a first part 1230a and a second part 1230b, although two or more separate filter units can also be used with similar technical effect. Each valve arrangement 1210, 1220 is configured to generate a reverse thrust of air to clean an associated part 1230a, 1230b of the pre-filter system 1230 in response to a control signal from the control unit 170, 900, as discussed above.

The control unit 170, 900 is optionally Arranged to determine a weight of dust D1 inside the dust separator 110 based on the data indicative of the load measured by the one or more load sensors 210, 220, as discussed above, e.g., in connection to FIG. 5, and to actuate the first and the second valve arrangements 1210, 1220 with an at least partial time overlap in case the weight of dust D1 inside the dust separator 110 fails to meet an acceptance criterion, such exceeding a weight threshold or falling outside of a weight range. By actuating the first and the second valve arrangements 1210, 1220 at the same time a particularly strong reverse thrust of air is generated which passes through both the first part 1230a and the second part 1230b of the pre-filter system 1230. This strong reverse thrust of air is also likely to open a separating structure, such as a hatch or the cone discussed in connection to FIGS. 4A-D, thereby triggering an emptying operation where dust held inside the dust separator is evacuated into an associated dust container.

FIG. 7 illustrates an example interface 700, by which an operator can receive information about the status of the dust extractor. This particular example is a portable device 710, such as a smart phone or tablet, but other interfaces can also be used, such as a display attached directly to the dust extractor 100. This device 710 is arranged to communicate via wireless link to a remote server 720, whereby the device 710 can receive configuration data 730 (such as load thresholds, load data filtering settings, and expected dust extraction rates) and also report measurements of, e.g., accumulated dust and slurry, as well as dust extraction rates, at least periodically. The interface 700 may also be arranged to display a time variation in dust extraction rate, as illustrated in FIG. 11.

The control unit 170, 900 is optionally arranged to transmit data indicative of the determined dust extraction rate 740, the time variation in dust extraction rate, and/or the determined weight of extracted dust to the remote server 180, 720, e.g., via the wireless link 725. This remote server may then keep track of the dust extractor in terms of, e.g., the usage pattern. A dust extractor having extracted a large weight of dust is more likely to require servicing compared to a dust extractor which has not extracted a lot of dust. Thus, the remote server 180, 720 may schedule servicing of the dust extractors in a fleet of dust extractors based on the data obtained from the control units. The remote server 180, 720 may also estimate a future need for new pre-filters and essential filters, based on the estimated total amount of extracted dust by the dust extractor at, e.g., some construction site, as a function of time. The remote server 180, 720 may learn over time how a filter is subject to wear as function of dust extraction rate and use this information to predict when filter replacement is necessary in order to maintain dust extraction capability. The control unit 170, 900 can also be arranged to determine an expected time instant 760 for preferred emptying of a dust container based on the determined dust extraction rate, as discussed above. The control unit 170 may, for instance, be configured 730 with a preferred maximum weight, and then trigger a notification 760 or even an alarm signal if the total accumulated weight of dust and slurry exceeds this preferred maximum weight. This way dust container emptying can be made more efficient, and too heavy dust containers can be avoided.

Data indicative of dust weight, such as the weight of dust supported by the hatch mechanism 410 and the weight of dust supported by the dust container 530 can also be communicated to dust generating equipment such as a floor grinder, or other devices such as a remote control associated with the dust extractor. This way an operator of, e.g., the floor grinder or some other form of concrete processing equipment can obtain valuable information in a convenient manner. Data indicative of the determined dust extraction rate can also be communicated to dust generating equipment associated with the dust extractor. This allows the current dust generation rate (which can be assumed to be similar to the dust extraction rate) to be displayed on a display of the construction equipment that is generating the dust, which is an advantage. An operator can then quickly see if the construction equipment all of a sudden generates less dust than expected, or more dust than expected, given the current concrete processing operation. The weight data received from the dust extractor at the dust generating construction equipment can also be used by the operator or by a control unit to optimize the operation of the dust generating equipment, e.g., by controlling a drive unit power or other machine setting, such as a weight applied to the concrete processing tool.

In other words, construction equipment comprising a control unit 900 is disclosed herein, that is arranged to communicate with a heavy-duty dust extractor 100, 200, 300, 400, 500, 600 according to the above discussion. The control unit 900 is arranged to receive data indicative of a weight of extracted dust and/or indicative of a current dust extraction rate from the heavy-duty dust extractor 100, 200, 300, 400, 500, 600, and to control at least one function of the construction equipment based on the received data. The construction equipment may for instance comprise a display unit similar to the display unit 700 discussed above in connection to FIG. 7. I.e., at least one function of the construction equipment comprises displaying, by the display unit, any of; a weight of extracted dust by the dust extractor, a weight of extracted dust supported in a dust container of the dust extractor, a dust extraction rate of the dust extractor, a notification indicating a discrepancy between a current dust extraction rate of the dust extractor and an expected dust extraction rate of the dust extractor, and/or a notification indicating that a weight of dust in the dust extractor exceeds a dust weight threshold.

The construction equipment may also comprise a drive unit, in which case the control unit 900 of the construction equipment can be arranged to control an operation of the drive unit based on the received data from the heavy-duty dust extractor. The control unit can increase or decrease the power applied by the drive unit in order to adjust the amount of generated dust by the construction equipment (which can be inferred from the data on extracted dust). The control unit can for instance increase or decrease a speed of rotation by a concrete processing tool to adjust the amount of generated dust to be closer to a desired dust generation rate, and/or an applied force or torque to the tool, given the current tool and work task to be performed by the construction equipment.

According to some aspects, the control unit 170 of the dust extractor 100 is arranged to control an operating rate or power of the construction equipment that generates the dust, which is extracted by the dust extractor, based on the rate of accumulated dust in the dust extractor. The control unit 170 is then able to optimize the amount of generated dust to an amount which can be efficiently handled by the dust extractor, i.e., one which is not too large to handle by the dust extractor nor too small to result in inefficient processing. These aspects are particularly suitable for construction equipment which can control the amount of generated dust in a straightforward manner, such as shot blasters and shavers where the processing power can be adjusted to control the amount of generated dust during operation.

The construction equipment may also comprise a variable tool contact pressure arrangement by which the weight or force applied to a concrete processing tool can be adjusted to optimize the concrete processing operation. More of less weight can, for instance, be applied to the grinding heads of a floor grinder in order to process the concrete surface more or less aggressively. The control unit 900 of the construction equipment is then optionally arranged to control the weight or force applied to a concrete processing tool of the construction equipment based on the received data from the heavy-duty dust extractor either by automatic adjustment or by instructions to an operator via a display device.

The control unit 900 may furthermore be arranged to transmit a signal back to the heavy-duty dust extractor comprising an instruction to perform a dust separator emptying operation, in response to a user input and/or in response to that the weight of extracted dust exceeding a predetermined threshold weight.

The construction equipment can also be arranged to control a liquid dispenser of the equipment based on the received data. This way a supply of liquid, such as water, to the work object being processed by the equipment can be controlled. Both activation/deactivation and the amount of liquid can also be controlled based on the received data, i.e., based on the dust generation rate of the construction equipment.

According to some further aspects, the control unit 170, 900 in the dust extractor or in the dust generating construction equipment is arranged to determine a suitable choice of concrete processing tool based on the determined dust extraction rate and/or to determine when it is time to change tools based on the determined dust extraction rate, and/or when a work task is completed based on the determined dust extraction rate. Each tool may be associated 730 with an expected dust extraction rate. Then, if the current dust extraction rate does not agree with the expected dust extraction rate, a warning can be triggered 750, indicating that the tool choice is perhaps not ideal, or that some other suboptimality in the concrete processing operation is present. The expected dust extraction rate can be pre-configured 730 by a user, whereupon the control unit can indicate to the user when the expected dust extraction rate no longer occurs, whereupon the operator can decide to change tools. The control unit 170, 900 in the dust extractor or in the dust generating construction equipment may also be arranged to determine a suitable choice of concrete processing tool or time instant for tool change based on a time variation in the determined dust extraction rate. The time variation in determined dust extraction rate can also be used by the control unit to determine when a work task is nearing completion and/or has been completed.

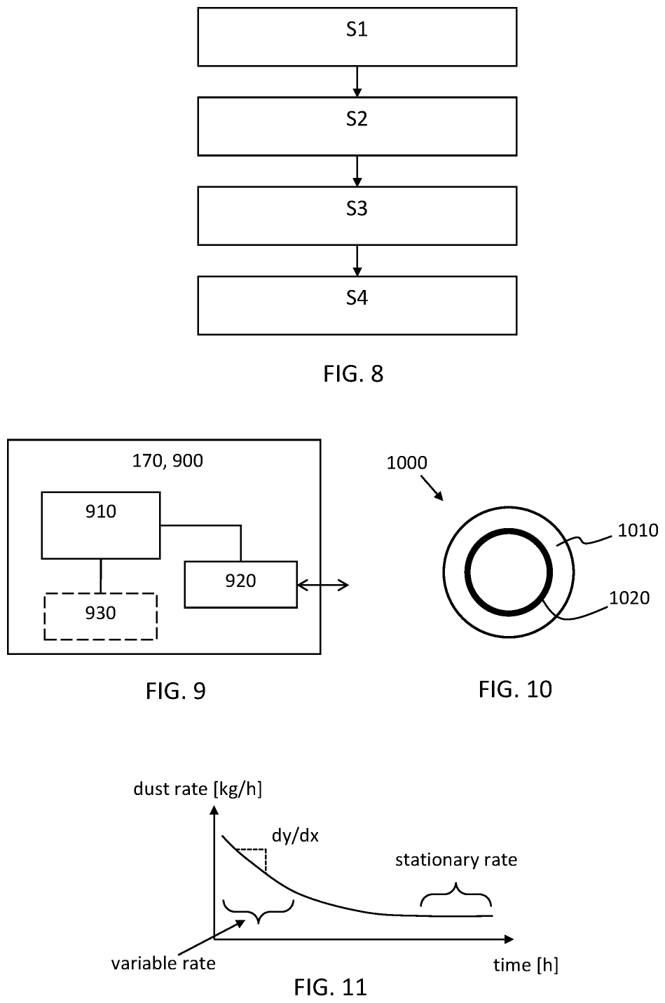

FIG. 8 is a flow chart illustrating a computer-implemented method that summarizes some of the above discussions. The method is performed in a heavy-duty dust extractor 100, 200, 300, 400, 500, 600 comprising a dust separator 110, wherein the heavy-duty dust extractor is arranged to be supported on a ground surface 101 by one or more support members 150, 160. The method comprises arranging S1 one or more load sensors 210, 220 in connection to the one or more support members 150, 160 to measure a load on the support members 150, 160, receiving S2, by a control unit 170, 900, data indicative of the load measured by the one or more load sensors 210, 220, determining S3, by the control unit 170, 900, a dust extraction rate 740 in terms of a weight of extracted dust per unit of time based on the received data, and controlling S4, by the control unit 170, 900, an operation of the heavy-duty dust extractor 100 based on the determined dust extraction rate.

FIG. 9 illustrates a control unit 900 comprising processing circuitry 910, a communications interface 910 coupled to the processing circuitry 910; and a memory module 930 coupled to the processing circuitry 910, wherein the memory module comprises machine readable computer program instructions that, when executed by the processing circuitry, causes the control unit to perform the different operations discussed above. The control unit 900 may, e.g., be used as the device control unit 170.

FIG. 9 also schematically illustrates, in terms of a number of functional units, the general components of the control unit 900. Processing circuitry 910 is provided using any combination of one or more of a suitable central processing unit CPU, multiprocessor, microcontroller, digital signal processor DSP, etc., capable of executing software instructions stored in a computer program product, e.g., in the form of a storage medium 930. The processing circuitry 910 may further be provided as at least one application specific integrated circuit ASIC, or field programmable gate array FPGA.

Particularly, the processing circuitry 910 is configured to cause the dust extractor to perform a set of operations, or steps, such as the methods discussed in connection to FIG. 8 and the discussions above. For example, the storage medium 930 may store the set of operations, and the processing circuitry 910 may be configured to retrieve the set of operations from the storage medium 930 to cause the device to perform the set of operations. The set of operations may be provided as a set of executable instructions. Thus, the processing circuitry 910 is thereby arranged to execute methods as herein disclosed.

The storage medium 930 may also comprise persistent storage, which, for example, can be any single one or combination of magnetic memory module, optical memory module, solid state memory module or even remotely mounted memory module.

The circuit may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the control unit, e.g., by sending data and control signals to the interface 920 and the storage medium 930, by receiving data and reports from the interface 920, and by retrieving data and instructions from the storage medium 930.

FIG. 10 illustrates a computer readable medium 1010 carrying a computer program comprising program code means 1020 for performing the methods illustrated in FIG. 8, when said program product is run on a computer. The computer readable medium and the code means may together form a computer program product 1000.

1-46. (canceled)

47. A heavy-duty dust extractor comprising a dust separator, one or more load sensors, and a control unit,
wherein the one or more load sensors are arranged to measure a weight of accumulated dust and/or slurry in at least a part of the dust extractor,
wherein the control unit is arranged to receive data indicative of the weight measured by the one or more load sensors, and to determine a weight of dust based on said data,
wherein the control unit is arranged to trigger an emptying operation wherein dust and/or slurry held inside the dust separator is evacuated from the dust separator into a dust container, based on the determined weight of dust.

48. The heavy-duty dust extractor according to claim 47, wherein the emptying operation comprises any of: controlling a valve to guide a reverse thrust of air backwards through a pre-filter system of the dust separator, controlling a valve to guide a flow of air from an external ambient environment into the dust separator, and/or actuating a separating structure such as a hatch mechanism or collapsible cone, to evacuate the dust and/or slurry from the dust separator into the dust container.

49. The heavy-duty dust extractor according to claim 47, wherein at least one load sensor comprises a load cell arranged to generate an electrical signal based on a tension, compression, pressure, or torque exerted by the ground surface on a respective support member of the heavy-duty dust extractor.

50. The heavy-duty dust extractor according to claim 47, comprising an inertial measurement unit, IMU, wherein the control unit is arranged to process the data indicative of the load measured by the one or more load sensors, conditioned on that the IMU outputs a signal indicative of dust extractor stationarity.

51. The heavy-duty dust extractor according to claim 47, wherein the control unit is arranged to determine the weight of extracted dust by averaging the data indicative of the load measured by the one or more load sensors.

52. The heavy-duty dust extractor according to claim 47, wherein the control unit is arranged to transmit data indicative of the determined weight of extracted dust to a remote server and/or to dust generating equipment or other construction equipment associated with the dust extractor.

53. A heavy-duty dust extractor comprising one or more load sensors, a control unit, at least one valve arrangement and a dust separator with a pre-filter system,
wherein the at least one valve arrangement is configured to generate a reverse thrust of air through the pre-filter system upon actuation by the control unit,
wherein the one or more load sensors are arranged to measure a weight of accumulated dust and/or slurry in the dust extractor,
wherein the control unit is arranged to receive data indicative of the weight of accumulated dust and/or slurry in the dust extractor, and to actuate the at least one valve arrangement based on the weight.

54. The heavy-duty dust extractor according to claim 53, wherein the reverse thrust of air causes opening of a separating structure, such as a hatch or a cone, thereby triggering an emptying operation wherein dust held inside the dust separator is evacuated into an associated dust container.

55. The heavy-duty dust extractor according to claim 53,
wherein the control unit is arranged to determine a dust extraction rate in terms of a weight of extracted dust per unit of time based on the received data,
wherein the control unit is arranged to configure an actuation frequency or interval of the at least one valve arrangement based on the dust extraction rate.

56. The heavy-duty dust extractor according to claim 53, comprising at least a first and a second valve arrangement, wherein the pre-filter system comprises at least a first part and a second part,
wherein each valve arrangement is configured to generate a reverse thrust of air to clean an associated part of the pre-filter system in response to a control signal from the control unit.

57. The heavy-duty dust extractor according to claim 56,
wherein the control unit is arranged to determine a weight of dust held inside the dust separator based on the data indicative of the load measured by the one or more load sensors,
wherein the control unit is arranged to actuate the first and the second valve arrangements with an at least partial time overlap in case the weight of dust held inside the dust separator fails to meet an acceptance criterion.

58. The heavy-duty dust extractor according to claim 53, wherein the pre-filter system comprises a pre-filter with a filter aperture and a filter side wall, wherein the side wall is arranged to permit a flow of air to pass the side wall and to prevent at least some particulate matter from passing the side wall,
wherein the filter side wall extends away from the filter aperture and tapers inwards towards a center axis of the filter to define a filter interior volume,
wherein the pre-filter is arranged to hold a separating wall in position in the filter interior volume to divide the filter interior volume into the first and second parts.

59. The heavy-duty dust extractor according to claim 53, wherein the pre-filter system comprises two separate pre-filters constituting the first and second parts.

60. Construction equipment comprising a control unit arranged to communicate with a heavy-duty dust extractor, wherein the control unit is arranged to receive data from the dust extractor indicative of a weight of extracted dust and/or data indicative of a dust extraction rate, and to control at least one function of the construction equipment based on the received data.

61. The construction equipment according to claim 60, wherein the construction equipment comprises a drive unit, wherein the control unit is arranged to control an operation of the drive unit based on the received data from the heavy-duty dust extractor.

62. The construction equipment according to claim 60, wherein the construction equipment comprises a variable tool contact pressure arrangement, wherein the control unit of the construction equipment is arranged to control a force applied to a concrete processing tool of the construction equipment based on the received data from the heavy-duty dust extractor.

63. The construction equipment according to claim 60, wherein the control unit of the construction equipment is arranged to transmit a signal to the heavy-duty dust extractor comprising an instruction to perform a dust separator emptying operation, in response to a user input and/or in response to that the weight of extracted dust exceeding a predetermined threshold weight.

64. The construction equipment according to claim 60, wherein the construction equipment is arranged to determine a suitable choice of concrete processing tool based on the dust extraction rate and/or based on a time variation in dust extraction rate, and/or to determine a time instant for preferred tool change based on the determined dust extraction rate and/or based on the time variation in dust extraction rate.

65. The construction equipment according to claim 60, wherein the construction equipment is arranged to control a liquid dispenser of the equipment based on the received data.

66. The construction equipment according to claim 60, wherein the construction equipment comprises any of; a floor grinder, a concrete wall saw, a power cutter, core drilling equipment, a shaver, a scarifier, a shot blaster, a steel blaster, a remote control device arranged to control a concrete processing machine, and/or a portable display unit.
